(19) United States
(12) Patent Application Publication
(10) Pub. No.: US 2025/0217700 A1
(43) Pub. Date: Jul. 3, 2025

(54) Device for Creating Digital Persona

(71) Applicant: Morphusai Co., Ltd., Taipei City (TW)

(72) Inventors: Chia-Chun HSIEH, Taichung City (TW); Wei-Xiang Ni, New Taipei City (TW)

(21) Appl. No.: 18/807,655

(22) Filed: Aug. 16, 2024

(30) Foreign Application Priority Data
Dec. 27, 2023 (TW) 112150963

(51) Int. Cl. G06N 20/00; G06T 13/40; G10L 13/08

(52) U.S. Cl. CPC G06N 20/00; G06T 13/40; G10L 13/08

(57) ABSTRACT

A device for creating digital persona, which includes a data collection module responsible for collecting personality data of a target object, a personality training module utilizing a large language model and the personality data to train and generate a virtual personality model with personality characteristics of the target object, thereby generating a virtual personality consistent with the personality characteristics of the target object, an appearance video generation module and voice generation module respectively utilizing face replacement and voice cloning technologies to extract the pictures and sounds from the personality data to generate a virtual personality model with the appearance and voice characteristics of the target object, a lip synchronization module, utilizing lip synchronization technology to ensure that the mouth shape and voice of the digital persona are synchronized, and an interactive module, providing an interactive interface that allows users to interact with the virtual personality and receive responses from it.

### CROSS-REFERENCE TO RELATED APPLICATIONS

The present application is based on, and claims priority from TAIWAN patent application serial numbered 112150963, the disclosure of which is hereby incorporated by reference in its entirety.

### TECHNICAL FIELD

The present invention relates to technical field of artificial intelligence (AI) technology and more particularly, relates to digital persona technologies that create specific external and internal characteristics.

### BACKGROUND

In recent years, the rapid development of artificial intelligence (AI) technologies has made it possible to generate and interact with virtual personalities. With the advancement of artificial intelligence (AI) technology, virtual characters and virtual assistants are increasingly used in the fields of entertainment, education and business.

At present, virtual character synthesis can be applied in different occasions. For example, in the online education programs, virtual teachers provide teaching services, which can not only greatly reduce the burden of teachers, but also reduce teaching costs. Compared with simple recording and broadcasting of classes, virtual teachers can offer a better teaching experience. In addition, virtual characters can also be used in a wider range of situations to provide greater commercial value, such as artificial intelligence (AI) news anchors, games, animations, applications and other actual business scenarios. In order to improve the realism and interactivity of virtual characters, multiple technologies need to be combined to create and optimize the characters. The synthesis of avatars in the existing technology can generate corresponding lip change images based on the input audio data to simulate the mouth movements when speaking.

However, the aforementioned methods can only individually deal with appearance, voice or personality characteristics, and lack a comprehensive framework to integrate these different elements. Additionally, creating virtual personalities with natural interactive capabilities is a challenge, especially in scenarios that require a high degree of personalization and realism.

### SUMMARY

The purpose of the present invention is to provide an apparatus for creating digital persona, which includes a processor; a storage device couple to the processor; a data collection module, stored in the storage device and accessible through the processor, configured to collect personality data of a target object; a personality training module, stored in the storage device and accessible through the processor, configured to utilize a large language model and the personality data to train and generate a virtual personality model with personality characteristics of the target object, thereby generating a virtual personality consistent with the personality characteristics of the target object; an appearance video generation module, stored in the storage device and accessible through the processor, configured to utilize a face replacement software to extract pictures from the personality data to generate appearance characteristics of the target object; a voice generation module, stored in the storage device and accessible through the processor, configured to utilize a voice cloning software having voice cloning and text to speech functionalities to extract audio data from the personality data, to receive text responses from the virtual personality model and to convert the text responses into speech, and then to generate voice characteristics of the target object; and a lip synchronization module, stored in the storage device and accessible through the processor, configured to use a lip synchronization software to ensure that mouth shape and voice of the digital persona are synchronized when the digital persona is talking and to generate interactive videos, wherein the digital persona is generated by combining the virtual personality, the appearance and voice characteristics of the target subject.

In one preferred embodiment, the apparatus for creating digital persona of claim 1, further comprising an interactive module, stored in the storage device and accessible through the processor, configured to provide an interactive interface that allows users to interact with the virtual personality and receive responses from it.

In one preferred embodiment, the target object is a real person or a virtual idol.

In one preferred embodiment, the personality data of said target object includes appearance, voice and text data of said target object.

In one preferred embodiment, the personality training module includes: a data collection and analysis module, stored in the storage device and accessible through the processor, configured to collect, clean and format the textual data of the target object; a long-term memory, stored in the storage device and accessible through the processor, configured to connect the virtual personality model for receiving and storing processed textual data of the target object, wherein the large language model and the processed textual data are used to train the virtual personality model so that it can generate a virtual personality and dialogue matching the target object; and a short-term memory, stored in the storage device and accessible through the processor, configured to couple with the virtual personality model, used to receive the virtual personality and dialogue matching the target personnel to update iterative training data, enabling the conversational apparatus to maintain coherence with previous dialogues.

In one preferred embodiment, the personality training modules further includes a prompt input interface configured to input prompts, which include personality setting of the target subject, to simulate conversation style and knowledge background of the target personnel. The prompt input interface is configured to couple with said virtual personality model.

In one preferred embodiment, the large language model includes Chatgpt, LLAMA, and Bard.

In one preferred embodiment, the processor includes a multi-core central processing unit (CPU), a graphics processor unit (GPU), a digital signal processor (DSP), an application specific integrated circuit (ASIC), or their combinations.

In one preferred embodiment, the face swapping software includes FaceSwap program code.

In one preferred embodiment, the voice cloning software having voice cloning and text to speech functionalities includes Lovo.ai, Murf.ai, Resemble.ai program codes or the like.

In one preferred embodiment, the lip synchronization software includes Wav2Lip program code, Sadtalker program code or the like.

In one preferred embodiment, the virtual personality model is based on a transformer architecture and has a deep learning architecture for processing sequence data, which includes multiple layers of encoder and decoder with a self-attention mechanism used to capture long-range dependencies in the sequence data.

In one preferred embodiment, the process for creating a digital persona with the appearance, voice and personality of the target object includes executing the following steps through the processor: collecting photos, audio, video and text data of the target subject from public sources by the data collection module; training and generating the virtual personality model of the target subject by utilizing the large language model to input text data of the target subject, to produce a virtual personality with characteristics of the target subject; creating appearance and sound characteristics of the target subject through extracting photos and sounds of the target subject by respectively using the face replacement software from the appearance video generation module and the sound cloning software from the voice generation module; and ensuring that the digital persona can keep mouth shape and voice in synchronized by the lip synchronizing software form the lip synchronization module when the digital persona is speaking.

In one preferred embodiment, the device for creating digital persona further including executing the following step through the processor: allowing users to interact with the virtual personality by providing an interactive interface from the interactive module and to obtain responses.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a functional block diagram of a device for creating digital persona according to an embodiment of the present invention.

FIG. 2 shows a functional block diagram of a personality training module in a device for creating a digital persona according to an embodiment of the present invention.

FIG. 3 shows the device for creating a digital person mentioned in FIG. 1, and the process of creating a digital persona with the appearance, voice and personality of the target object.

FIG. 4 shows a functional block diagram of an exemplary computer system/server for implementing embodiments of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

As a branch of Artificial Intelligence (AI) technology, a technology called digital persona has begun to be used in various scenarios such as short video platforms, live broadcasts, and online education. The so-called digital persona refers to a virtual character that uses AI technology to virtually simulate the shape and function of the human body at different levels. With the rapid development of AI and image processing technologies, digital persona generation technology is becoming more and more mature. Take the application of digital persona technology to video technology as an example. It can construct a false object image through deep learning, and use voice to drive the facial expressions of the virtual object to simulate speaking of a real person.

With the rapid development of AI technology, the acceptance of AI has become an important issue. Although AI technology has shown great potential in many fields, many people are still skeptical or unfamiliar with it. In order to break through this obstacle, the present invention aims to create a digital persona with the appearance and personality traits of a real person through AI technology. Through similar appearance, voice and personality traits to real people, this digital persona can not only establish a deeper connection with human users, but also create a sense of intimacy and trust during their interactions. When AI can be more naturally adapted into our daily lives and establish real emotional connections with us, human civilization will usher in further evolution. This not only helps to accelerate the popularization of AI, but also brings new development opportunities to our society, culture and economy.

The present invention proposes a device for creating a digital persona, in particular a digital persona that can generate a target virtual personality and interact with it by integrating external and internal characteristics.

In order to achieve the above goals, the present invention provides a new device and method by integrating advanced AI technologies, including but not limited to large language model (LLM), voice clone (Voice Clone TTS), and face replacement (FaceSwap). and lip-sync technologies (such as Wav2Lip or Sadtalker) to create and interact with digital persona with specific looks, voices, and personality traits. This combination not only provides a comprehensive framework to integrate appearance, voice and personality characteristics, but also ensures natural and smooth interaction with the virtual personality. The device and method provided by the present invention can be applied in a variety of fields, including entertainment, education and professional services, thereby bringing new interactive experiences and values.

According to an embodiment of the present invention, with reference to FIGS, 1 and 4, the device for creating a digital persons 100 proposed by the present invention includes a data collection module 101, a personality training module 103, and an appearance video generation module 105a, a voice generation module 105b, a lip synchronization module 107 and an interaction module 109. Among them, the data collection module 101 is responsible for collecting and organizing data, including appearance pictures, sounds and text data of the target subject, for training and generating the virtual personality of the target object through the operation of the processor 414 and storing them in the storage device 424; the personality training module 103, uses the large language model (LLM) and the text data provided above to train and generate a virtual personality model with the personality characteristics of the target object through the operation of the processor 414, the personality model can generate virtual personality consistent with the personality characteristics of the target object (target personnel); the appearance video generation module 105a utilizes face replacement technology, for example face swapping software like FaceSwap program code, to extract pictures from the data used for training and generating the target object, and generates appearance (such as face shape) features of the target object through the operation of the processor 414; the voice generation module 105b utilizes voice clone technology (Voice Clone TTS, i.e. Voice Clone software with voice cloning and text to speech functionality includes Lovo.ai, Murf.ai, Resemble.ai or other similar program codes) to extract the audio data, such as voice or sound signals, from the collected data used to train and generate virtual personality of the target object, can receive text responses from the virtual personality model and convert into speech, and then generate sound signatures with the target object form the audio data through the operation of the processor 414; the lip-sync module 107, through the operation of the processor 414, can use the lip-sync technology (Lip-Sync software, for example Wav2lip or Sadtalker program code) to ensure that the mouth shape and voice of the digital persona are synchronized when talking, and can generate interactive videos from the appearance features, the voice characteristics and the speech generated from the text responses to interactive with users, where the digital persona has the appearance and voice characteristics of the target object; the interactive module 109 provides an interactive interface that allows the users to interact with the virtual personality generated by the virtual personality model in a natural way, and can receive the interactive videos generated by the lip sync module 107 to obtain reasonable and meaningful responses. The digital persona is generated by combining the virtual personality generated by the virtual personality model, the appearance characteristics and said voice characteristics of said target subject.

According to some embodiments of the present invention, the aforementioned target object may be a real person or a virtual idol.

According to some embodiments of the present invention, the large language model (LLM) includes Chatgpt, LLAMA, Bard, etc. installed in the external connected large language model (LLM) server 106.

According to some embodiments of the present invention, the aforementioned face swapping software includes, but is not limited to, FaceSwap program code based on Deepface Lab.

According to some embodiments of the present invention, the aforementioned lip synchronization software includes, but is not limited to, Wav2Lip and Sadtalker program codes.

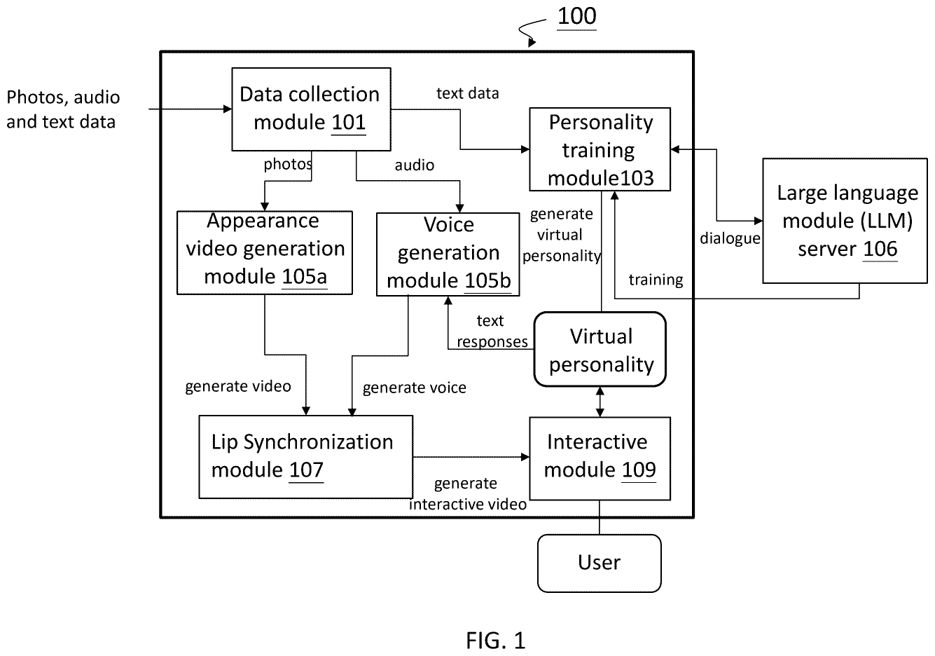

According to an embodiment of the present invention, with reference to FIGS. 1-2 and 4, the personality training module 103 is based on a large language model (LLM), which at least includes the following main parts:

Data collection and analysis module 212: By operating the processor 414, the data collection and analysis module 212 will extract and organize information from a large amount of textual and conversational contents of the target personnel (that is, collect and analyze the textual data of the target personnel) and store them in the long-term memory 214, which is a database stored in the storage device 424, used as training materials to construct and form the character. This long-term memory 214 will serve as the basis for model training, helping a virtual personality model 216 to understand and simulate the conversational style and knowledge background of a specific character (i.e., target personnel). According to one embodiment of the present invention, the data collection and analysis module 212 cleans, formats and tokens the collected language data about a specific personnel (target personnel), such as texts, conversation records or other forms of language expression, and stores them in the long-term memory 214 connected to the data collection and analysis module 212 for training the virtual personality model 216.

Virtual personality model 216: By operating the processor 414, the virtual personality model 216 can be trained by utilizing the large language model (LLM) and collected data to generate a model of a specific personnel's virtual personality and dialogue. According to one embodiment of the present invention, the virtual personality model 216 based on a large language model (LLM) can be operated by the processor 414, utilizing the cleaned and formatted language data of the target personnel stored in the long-term memory 214 together with the personality settings (set by the prompt input interface (prompt) 220) as training guidelines, and can be trained through an external connected large language model (LLM) (installed in the large language model (LLM) server 106). According to one embodiment of the present invention, the virtual personality model 216 is based on a transformer architecture, which is a deep learning architecture for processing sequence data, including multiple encoder and decoder layers with self-attention mechanism to capture long-range dependencies in the sequence data. According to one embodiment of the present invention, the virtual personality model 216 is operated by the processor 414, and the training process includes: (a) processing textual data and converting them into a digital representation that can be used in the model; (b) randomly assigning parameters of the model; (c) transmitting the digital representation of the textual data to the model; (d) learning through minimizing cross-entropy loss of next word; (e) updating weight in the model through back propagation algorithm to optimizing parameters of the model; (f) repeat the process until the output of the model reaches required accuracy. According to some embodiments of the present invention, once the virtual personality model 216 is trained, it can perform a variety of natural language processing (NLP) tasks, such as text generation, semantic understanding, sentiment analysis, question and answer, etc., and can understand complex language structures and meaning. Therefore, the trained virtual personality model 216 can be used to generate natural, fluent, and reasonable textual contents. The virtual personality creation system 104 uses the virtual personality model 216 to generate a large amount of conversational texts that match virtual personality and dialogue of the target personnel, thereby solving the shortage of textual contents of some character's personality; then, the data is cleaned, formatted and tokenized through the data collection and analysis module 212, and then the large amount of conversational texts that match virtual personality and dialogue of the target personnel are stored in the long-term memory 214. The trained virtual personality model 216 can generate summary of a large amount of conversations through interacting with user and then import them into a short-term memory 218, which is also a database, for updating iterative training data, allowing the virtual personality creation system 104 to maintain coherence with previous dialogue and knowledge backgrounds, thereby improving contextual understanding ability of the virtual personality model 216. Among them, the short-term memory 218 is connected between the data collection and processing module 212 and the virtual personality model 222.

Interactive module 202: It includes a user interface 202a that can exist within the virtual personality creation system 104 or be connected to the virtual personality creation system 104 by an external user terminal 102, allowing the user to interact with the generated virtual personality that matches the target personnel (i.e. the trained virtual personality model 216), to communicate, generate multi-round dialogue and provide a summary of the previous-round dialogue for offering the user with a natural and meaningful dialogue experience.

According to an embodiment of the present invention, the virtual personality model 216 can understand the context coherence of the multi-round dialog by utilizing the long-term memory 214 and the short-term memory 218, and can simulate the conversational style and knowledge background of the target personnel by inputting specific prompts, which can be character's personality settings, through the prompt input interface 220.

According to an embodiment of the present invention, the multi-round dialogue and the summary of the previous-round dialogue that are generated by the interactive module 202 are then cleaned and formatted through the data collection and analysis module 212, and then are fed into and stored in the short-term memory 218 to maintain coherence with previous conversations and knowledge background, thereby improving the context understanding ability of the virtual personality model.

In the present invention, a large language model (LLM) is used to train and generate the personality and dialogue of a specific personnel. By leveraging the natural language understanding capabilities of large language models (LLM), its LLM architecture and deep training mechanism can enable it to capture the nuances and complex structure of human language. Among them, the large language model (LLM) includes Chatgpt, LLAMA, Bard, etc. installed in the external large language model (LLM) server 106.

In the present invention, the parameters of the large language model (LLM), such as model size (number of layers and dimensions of hidden units), learning rate and training data size, etc., can be adjusted according to specific application requirements.

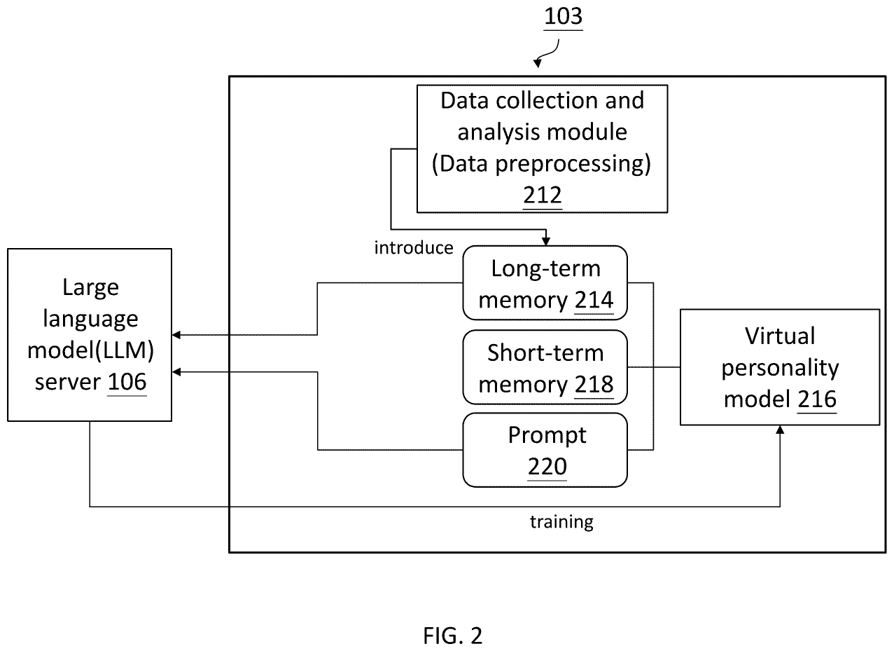

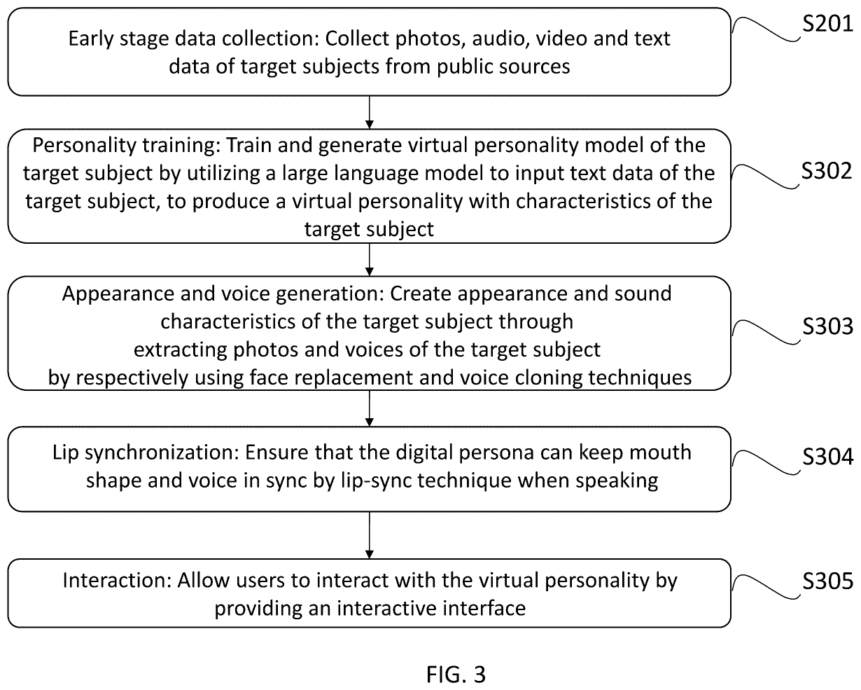

FIG. 3 shows the process of creating a digital persona with the appearance, voice and personality of a target object (target personnel) using the device 100 mentioned in FIG. 1 according to the present invention, including through the processor. Follow these steps: first, step S301, preliminary data collection step: collecting photos, audio and text data of the target object from public sources by using the data collection module 101 (refer to FIG. 1); step S302, personality training step: training to generate a virtual personality model with the personality characteristics of the target object by utilizing the personality training module 103 based on the large language model to input the text data of the above target object, and then generate a virtual personality model consistent with the personality characteristics of the target subject; step S303, appearance and voice generation step: creating the appearance and voice characteristics of the target object respectively utilizing face replacement and voice cloning technologies (i.e. respectively utilizing face swapping and voice cloning software) through the appearance video generation module 105a and the voice generation module 105b (refer to FIG. 1) to extract the pictures and voices in the personality data of the target object; step S304, lip synchronization step: ensuring that the mouth shape and voice of the aforementioned digital persona are synchronized by the lip synchronization module 107 (refer to FIG. 1) through utilizing lip synchronization (Lip-Sync) technology (i.e. utilizing lip synchronization software); step S305, interaction step: allowing the user to interact with the virtual personality and obtain reasonable and meaningful responses from the virtual personality model (refer to FIGS. 1-2) that has been trained through providing an interactive interface by the interaction module 109 (refer to FIG. 1).

The following paragraphs provide examples of specific implementations:

### Example 1: Real Person-Steve Jobs

(1). Preliminary data collection: Collecting Jobs' image, audio and textual data from public sources, including his speeches, interviews and writings.
(2). Personality training: Imitating Steve Jobs' language style and way of thinking through inputting Steve Jobs' text data to a large language model (LLM) to learn his language habits and can even generate similar creative ideas or suggestions.
(3). Generation of appearance and voice: Creating a virtual facial model of Steve Jobs using face swapping technology and extracting a picture of Steve Jobs from a public speech. At the same time, cloning his voice using Voice Clone TTS technology.
(4). Lip sync and interaction: ensuring that Steve Jobs' mouth shape and speech remain synchronized by Wav2Lip when the simulated Steve Jobs speaks. Users can ask him questions through an interface, such as “Jobs, what do you think of current technology trends?” and get simulated responses.

### Example 2: Virtual Idol

(1). Preliminary data collection: Collecting a series of conceptual sketches created by a designer; or a collection of songs and audio sample created by a music producer.
(2). Personality training: Design a personality for your virtual idol, such as optimism, humor, or mystery. This personality is then trained using a large language model, adding specific language and topic relevance.
(3). Generation of appearance and voice: Create a 3D model of your virtual idol using the provided sketches and FaceSwap technology. At the same time, Voice Clone TTS technology is used to clone or generate specific sounds based on samples provided by music producers.
(4). Lip sync and interaction: Ensure that virtual idol's mouth shape and voice remain in synchronized utilizing Wave2Lip when the virtual idol sings or speaks. Fans can interact with her through a specific platform, such as asking her about the inspiration for her songs, and get immediate responses.

The above two examples show how to use the device and method provided by the present invention to create and interact with digital persona with specific appearance, voice and personality according to different needs and data sources.

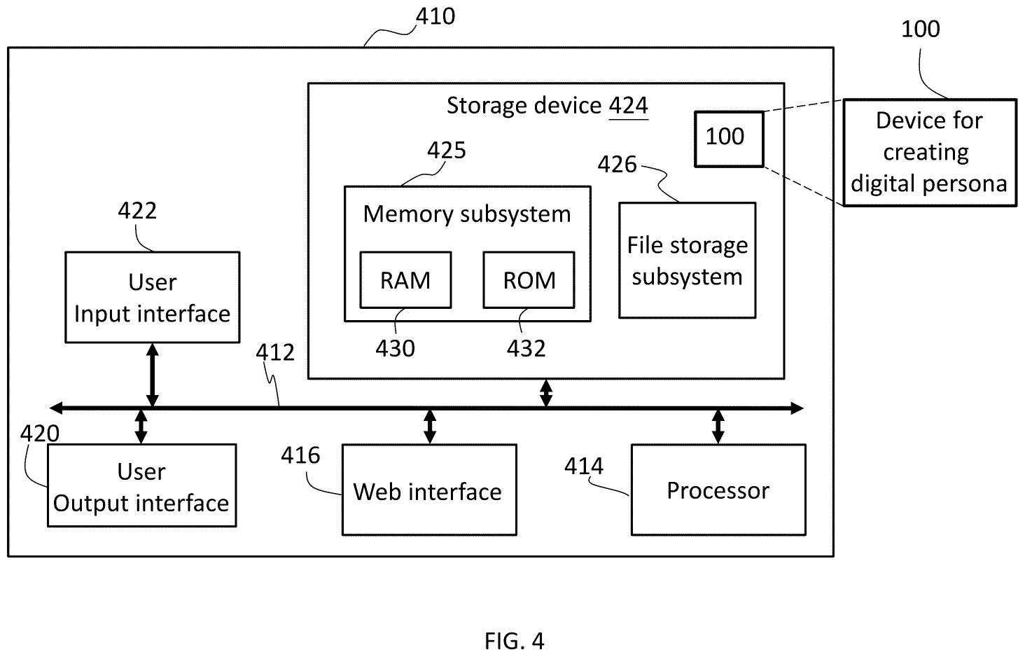

The above methods or embodiments proposed by the present invention can be executed in a server or similar computer system. For example, the calculation, calculation program and the device for creating digital persona 100 shown in FIGS. 1-3 can be executed through the processor 414 to process the required information and can be stored in the storage device 424. The device for creating digital persona 100 proposed by the present invention (refer to FIG. 1), which exists in a server or similar computer system 410 as shown in FIG. 4. Functional block diagram of the server or similar computer system 410 is illustrated in FIG. 4. It should be emphasized that the server/computer system shown in FIG. 4 is only used as an example and should not impose any limitations on the embodiments and scope of usages of the present invention.

As shown in FIG. 4, the server/computer system 410 is in the form of a general computing device. Server/computer system 410 typically includes at least one processor 414 that is communicatively connected to a plurality of peripheral devices through bus subsystem 412. These peripheral devices may include storage devices (e.g., memory subsystem 425 and file storage subsystem 426) 424, user output interface 420, user input interface 422, and network interface subsystem 416. The network interface subsystem 416 provides a connection interface to the external network and is coupled to corresponding interface devices of other computing devices.

According to embodiments of the present invention, the processor 414 may include a multi-core central processing unit (CPU), a graphics processor unit (GPU), a digital signal processor (DSP), an application specific integrated circuit (ASIC), or their combinations, etc.

User input interface 422 may interface with input devices including keyboard, pointing device such as mice, trackball, trackpad or graphics tablet, scanner, touch screen integrated into display, voice input device such as speech recognition system, microphone, and other types of input devices, etc.

User output interface 420 may interface with output devices including a display subsystem, a printer, a fax machine, or a non-visual display such as a sound output device. The display subsystem may include a cathode ray tube display (CRT), a flat panel device such as a liquid crystal display (LCD), a projection device, or other mechanism for producing visual images. The display subsystem may also provide non-visual displays by sound output devices.

Storage device 424 stores programming and data constructs that provide functionality for some or all modules described in the present invention. For example, a program or program module stored in the storage device may be configured to perform the functions of various embodiments of the invention. The aforementioned programs or program modules may be executed by the processor alone or in combination with other processors.

The memory subsystem 425 in the storage device 424 can include a plurality of memories, including a main random-access memory (RAM) 430 for storing instructions and data during program execution, and a read-only storage memory (ROM) 432 for storing fixed instructions. File storage subsystem 426 provides persistent storage for program and data files and may include hard drives, optical drives, or removable media cartridges. Functional modules for implementing certain embodiments may be stored in storage device 424 via file storage subsystem 426, or in other machines that can be retrieved/accessed by one or more processors.

The bus subsystem 412 provides a mechanism so that various components and subsystems of the computing device/device can communicate with each other in an expected manner. Although bus subsystem 412 is illustratively presented as a single bus, alternative implementations of bus subsystem 412 may use multiple buses.

Computing device may be of various types, including workstation, server, computing cluster, or other data processing system or computing device.

The present invention provides a new device and method, by integrating advanced AI technologies, including but not limited to large language model (LLM), voice clone (Voice Clone TTS), face replacement (FaceSwap) and lip Synchronization technologies (such as Wav2Lip or Sadtalker) to create and interact with digital persona with specific appearance, voice and personality traits. This combination not only provides a comprehensive framework to integrate appearance, voice and personality characteristics, but also ensures natural and smooth interaction with the virtual personality. The device and method provided by the present invention can be applied in a variety of fields, including entertainment, education and professional services, thereby bringing new interactive experiences and values.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. An apparatus for creating digital persona, comprising:
a processor;
a storage device couple to said processor;
a data collection module, stored in said storage device and accessible through said processor, configured to collect personality data of a target object;
a personality training module, stored in said storage device and accessible through said processor, configured to utilize a large language model and said personality data to train and generate a virtual personality model with personality characteristics of said target object, thereby generating a virtual personality consistent with said personality characteristics of said target object;
an appearance video generation module, stored in said storage device and accessible through said processor, configured to utilize a face swapping software to extract pictures from said personality data to generate videos with appearance characteristics of said target object;
a voice generation module, stored in said storage device and accessible through said processor, configured to utilize a voice cloning software having voice cloning and text to speech functionalities to extract audio data from said personality data, to receive text responses from said virtual personality model and to convert said text responses into speech, and then to generate voice characteristics of said target object from said audio data; and
a lip synchronization module, stored in said storage device and accessible through said processor, configured to utilize a lip synchronization software to ensure that mouth shape and voice of said digital persona are synchronized when said digital persona is talking and to generate interactive videos, wherein said digital persona is generated by combining said virtual personality, said appearance characteristics and said voice characteristics of said target subject.

2. The apparatus for creating digital persona of claim 1, further comprising an interactive module, stored in said storage device and accessible through said processor, configured to provide an interactive interface to receive said interactive videos generated by said lip synchronization module and allow users to interact with said virtual personality and receive responses from said virtual personality.

3. The apparatus for creating digital persona of claim 2, wherein said target object is a real person or a virtual idol.

4. The apparatus for creating digital persona of claim 3, wherein said personality data of said target object includes appearance, audio and text data of said target object.

5. The apparatus for creating digital persona of claim 4, wherein said personality training module includes:
a data collection and analysis module, stored in said storage device and accessible through said processor, configured to collect, clean and format said textual data of said target object;
a long-term memory data, stored in said storage device and accessible through said processor, configured to connect said virtual personality model for receiving and storing processed textual data of said target object, wherein said large language model and said processed textual data are used to train said virtual personality model so that it can generate a virtual personality and dialogue matching said target object; and
a short-term memory data, stored in said storage device and accessible through said processor, configured to couple with said virtual personality model, used to receive said virtual personality and dialogue matching said target personnel to update iterative training data, enabling said conversational apparatus to maintain coherence with previous dialogues.

6. The apparatus for creating digital persona of claim 5, wherein said personality training modules further includes a prompt input interface configured to input prompts, which include personality setting of said target subject, to simulate conversation style and knowledge background of said target personnel.

7. The apparatus for creating digital persona of claim 6, wherein said prompt input interface is configured to couple with said virtual personality model.

8. The apparatus for creating digital persona of claim 1, wherein said large language model includes Chatgpt, LLAMA, and Bard.

9. The apparatus for creating digital persona of claim 1, wherein said processor includes a multi-core central processing unit (CPU), a graphics processor unit (GPU), a digital signal processor (DSP), an application specific integrated circuit (ASIC), or their combinations.

10. The apparatus for creating digital persona of claim 1, wherein said face swapping software includes FaceSwap program code.

11. The apparatus for creating digital persona of claim 1, wherein said voice cloning software having voice cloning and text to speech functionalities includes Lovo.ai, Murf.ai, Resemble.ai program code or the like.

12. The apparatus for creating digital persona of claim 1, wherein said lip synchronization software includes Wav2Lip program code, Sadtalker program code or the like.

13. The apparatus for creating digital persona of claim 1, wherein said virtual personality model is based on a transformer architecture and has a deep learning architecture for processing sequence data, which includes multiple layers of encoder and decoder with a self-attention mechanism used to capture long-range dependencies in said sequence data.

14. The apparatus for creating digital persona of claim 4, wherein process for creating a digital persona with the appearance, voice and personality of said target object includes the following steps through the processor:
collecting photos, audio, video and text data of said target subject from public sources by said data collection module;
training and generating said virtual personality model of said target subject by utilizing said large language model to input text data of said target subject, to produce a virtual personality with personal characteristics of said target subject;
creating appearance and voice characteristics of said target subject through extracting photos and voices of said target subject by respectively using said face swapping software from said appearance video generation module and said voice cloning software from said voice generation module; and
ensuring that said digital persona can keep its mouth shape and voice in synchronized by said lip synchronizing software form said lip synchronization module when said digital persona is speaking.

15. The apparatus for creating digital persona of claim 14, further including executing the following step through said processor:
allowing users to interact with said virtual personality by providing an interactive interface from said interactive module and to obtain responses.

16. The apparatus for creating digital persona of claim 5, wherein said long term memory is served as basis for model training, helping said virtual personality to understand and simulate conversational style and knowledge background of said target object.
